(19) United States
(12) Patent Application Publication
(10) Pub. No.: US 2025/0376342 A1
(43) Pub. Date: Dec. 11, 2025

(54) ORIENTATION CORRECTION APPARATUS

(71) Applicant: ISUZU MOTORS LIMITED, Yokohama-shi (JP)

(72) Inventors: Muneyuki OSAWA, Fujisawa-shi (JP); Koya TOKUHARA, Fujisawa-shi (JP); Takahito HOSHI, Fujisawa-shi (JP)

(21) Appl. No.: 19/182,239

(22) Filed: Apr. 17, 2025

(30) Foreign Application Priority Data
Jun. 11, 2024 (JP) 2024-094216

(51) Int. Cl. B65G 69/00

(52) U.S. Cl. CPC B65G 69/006

(57) ABSTRACT

An orientation correction apparatus includes a receiving platform that supports one wheel of a vehicle; a lifting mechanism that lifts and lowers the receiving platform, which supports the wheel, between a lowered position and a raised position; and a stopper that is positioned at a standby position when the receiving platform is in the lowered position, and is positioned at the restricting position for restricting movement of the wheel from the receiving platform when the receiving platform is in the raised position. The lifting mechanism moves the stopper from the standby position to the restricting position in conjunction with movement of the receiving platform from the lowered position to the raised position.

### CROSS-REFERENCE TO RELATED APPLICATIONS

The present application claims priority to Japanese Patent Application number 2024-94216, filed on June 11, 2024 contents of which are incorporated herein by reference in their entirety.

### BACKGROUND OF THE INVENTION

The present disclosure relates to an orientation correction apparatus for correcting an orientation of a vehicle. Conventionally, in battery replacement systems, devices that correct the orientation of a stationary vehicle have been known. For example, Japanese Unexamined Patent Application Publication No. 2012-6591 discloses a device that corrects the orientation of a vehicle by lifting a conveyor (receiving platform) that supports the wheels of the stationary vehicle.

It is assumed that an external force may act on the wheels supported by the receiving platform. If the receiving platform rises while forces are acting on the wheels, there is a risk that the wheels may shift on the receiving platform and fall off.

### BRIEF SUMMARY OF THE INVENTION

The present disclosure has been made in view of these points, and its object is to prevent the wheels from falling off while a receiving platform rises.

A first aspect of the present disclosure provides an orientation correction apparatus for correcting an orientation of a vehicle, the orientation correction apparatus including: a receiving platform that supports one wheel of the vehicle; a lifting mechanism that lifts and lowers the receiving platform, which supports the wheel, between a lowered position and a raised position; and a stopper that is positioned at a standby position when the receiving platform is in the lowered position, and is positioned at a restricting position for restricting movement of the wheel from the receiving platform when the receiving platform is in the raised position, wherein the lifting mechanism moves the stopper from the standby position to the restricting position in conjunction with movement of the receiving platform from the lowered position to the raised position.

### BRIEF DESCRIPTION OF THE DRAWINGS

FIG. 1 is a schematic diagram illustrating a configuration of a battery replacement system S in which an orientation correction apparatus 1 is installed.

FIG. 2 is a schematic diagram illustrating a state in which the orientation correction apparatus 1 has raised a wheel 110 to a raised position.

FIG. 3 is a perspective view showing the orientation correction apparatus 1 when a receiving platform 10 is positioned at a lowered position.

FIG. 4 is a perspective view showing the orientation correction apparatus 1 when the receiving platform 10 is positioned at the raised position.

FIG. 5A is a schematic view showing a standby position and a restricting position of a stopper 30.

FIG. 5B is a schematic view showing a standby position and a restricting position of a stopper 30.

FIG. 6 is a schematic diagram showing a modification.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### Overview of an orientation correction apparatus

An orientation correction apparatus according to one embodiment corrects the orientation of a stationary vehicle. The orientation of the vehicle is defined in terms of yaw angle, roll angle, and pitch angle, for example. Here, the orientation correction apparatus is installed in a battery replacement system that automatically replaces a battery mounted on a vehicle, but is not limited thereto. The orientation correction apparatus may also be installed in a system that performs vehicle maintenance.

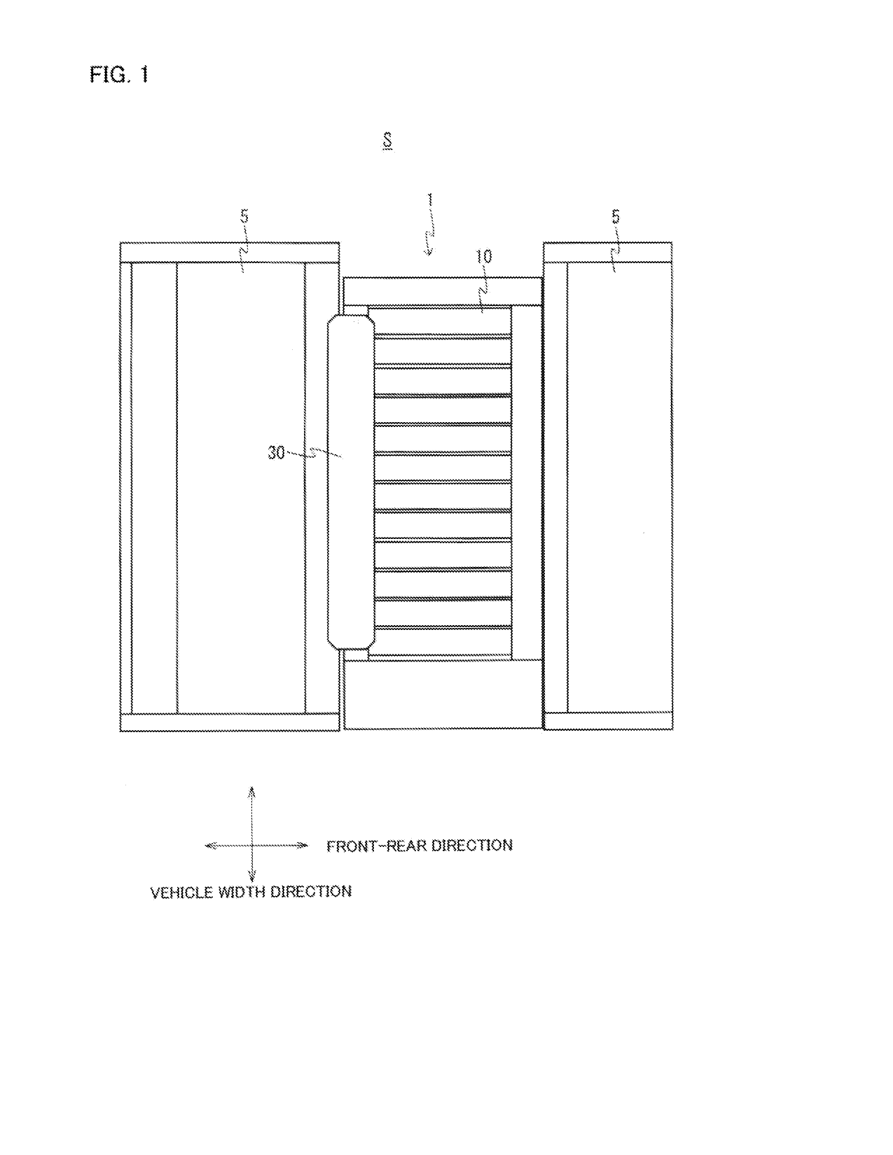

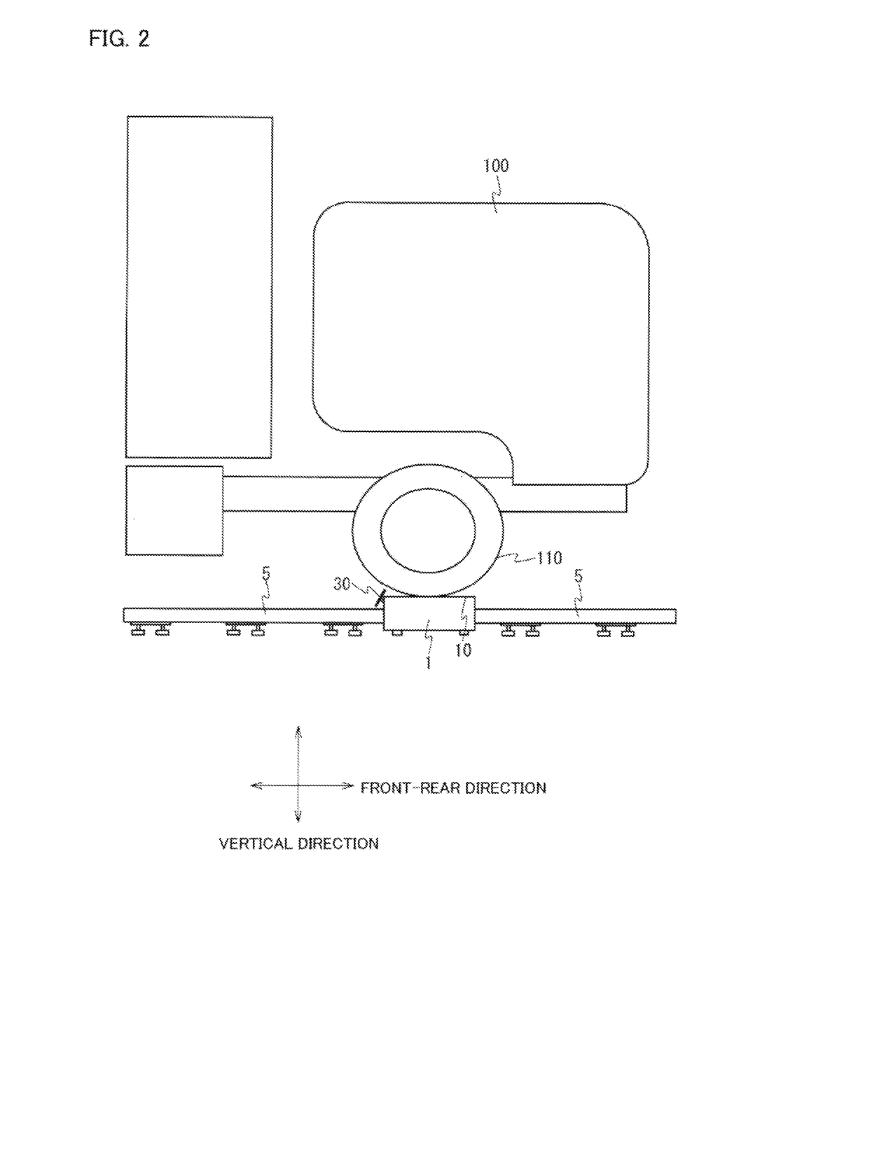

FIG. 1 is a schematic diagram illustrating a configuration of a battery replacement system S in which an orientation correction apparatus 1 is installed. FIG. 2 is a schematic diagram illustrating a state in which the orientation correction apparatus 1 has raised a wheel 110 to a raised position. In FIG. 1, as a matter of convenience, only a part of the battery replacement system S is shown, omitting components such as a device for automatically replacing a battery.

The battery replacement system S includes the orientation correction apparatus 1 and a vehicle platform 5. The orientation correction apparatus 1 is provided at a position corresponding to each wheel at a stopping position of the vehicle 100. In FIG. 1, only the orientation correction apparatus 1 corresponding to the right front wheel of the vehicle 100 is shown, but in actuality, a plurality of orientation correction apparatuses 1 are installed.

The vehicle platform 5 serves as a path along which the vehicle 100 proceeds. Specifically, the vehicle platform 5 forms a path along which the wheels 110 of the vehicle 100 pass. The vehicle platform 5 is disposed in front of and behind the orientation correction apparatus 1.

The orientation correction apparatus 1 corrects the orientation of the vehicle before its battery is replaced. That is, the orientation correction apparatus 1 corrects the orientation of the stationary vehicle 100 in order to make it easier for the replacement device to replace the battery. For example, the orientation correction apparatus 1 corrects the orientation of the vehicle 100 by moving the wheels 110 of the stationary vehicle 100 in both the vehicle width direction and the vertical direction.

The orientation correction apparatus 1 includes a receiving platform 10 that supports the wheels 110. For example, in order to replace the battery, as shown in FIG. 2, the orientation correction apparatus 1 raises the receiving platform 10 supporting the wheel 110. At this time, when an external force acts on the wheel supported by the receiving platform 10, the wheel may shift on the receiving platform 10.

On the other hand, the orientation correction apparatus 1 of the present embodiment includes a stopper 30 that restricts movement of the wheel when the receiving platform 10 is raised, the details of which will be described later. The stopper 30, here, restricts rearward movement of the wheel to keep the wheel 110 on the receiving platform 10. In particular, since the stopper 30 pivots in conjunction with the movement of the receiving platform 10 and is positioned at a restricting position, it is possible to prevent the wheel 110 from falling from the receiving platform 10 while the receiving platform 10 rises.

### Detailed configuration of the orientation correction apparatus

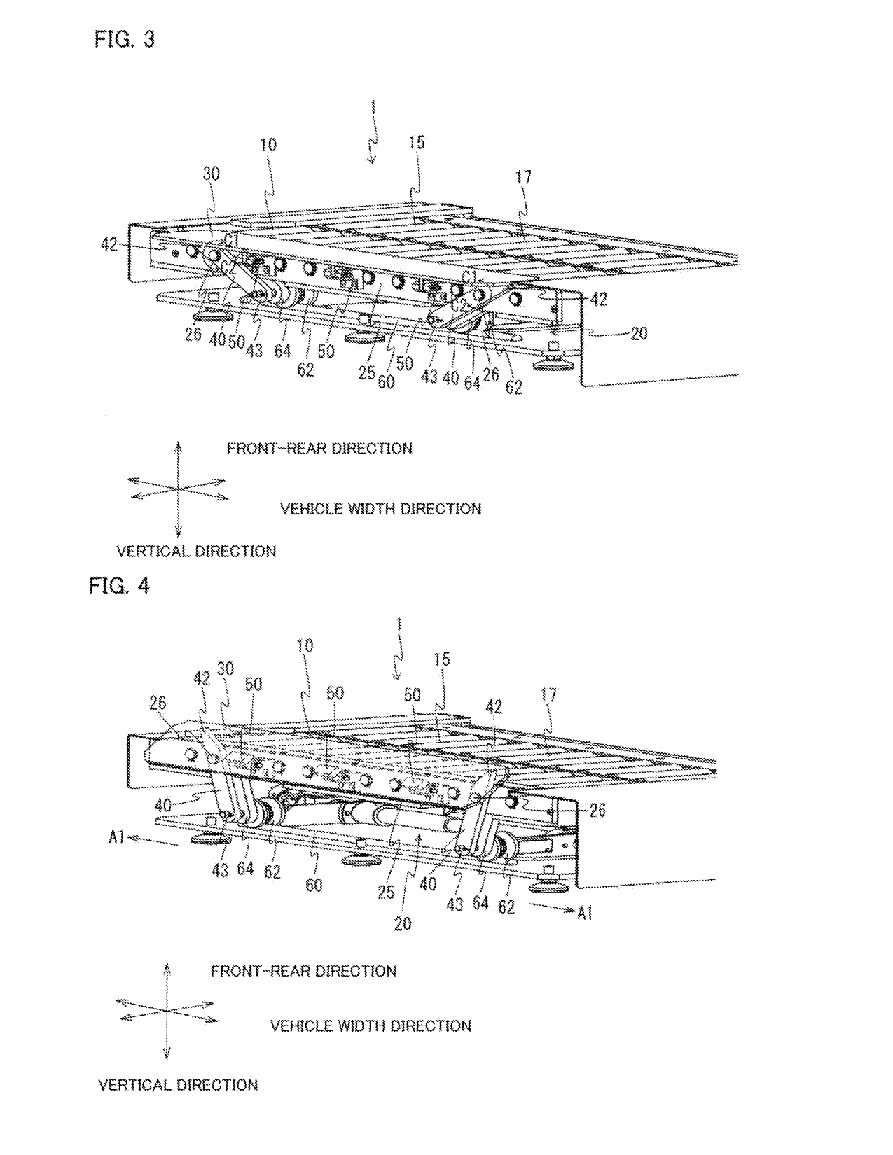

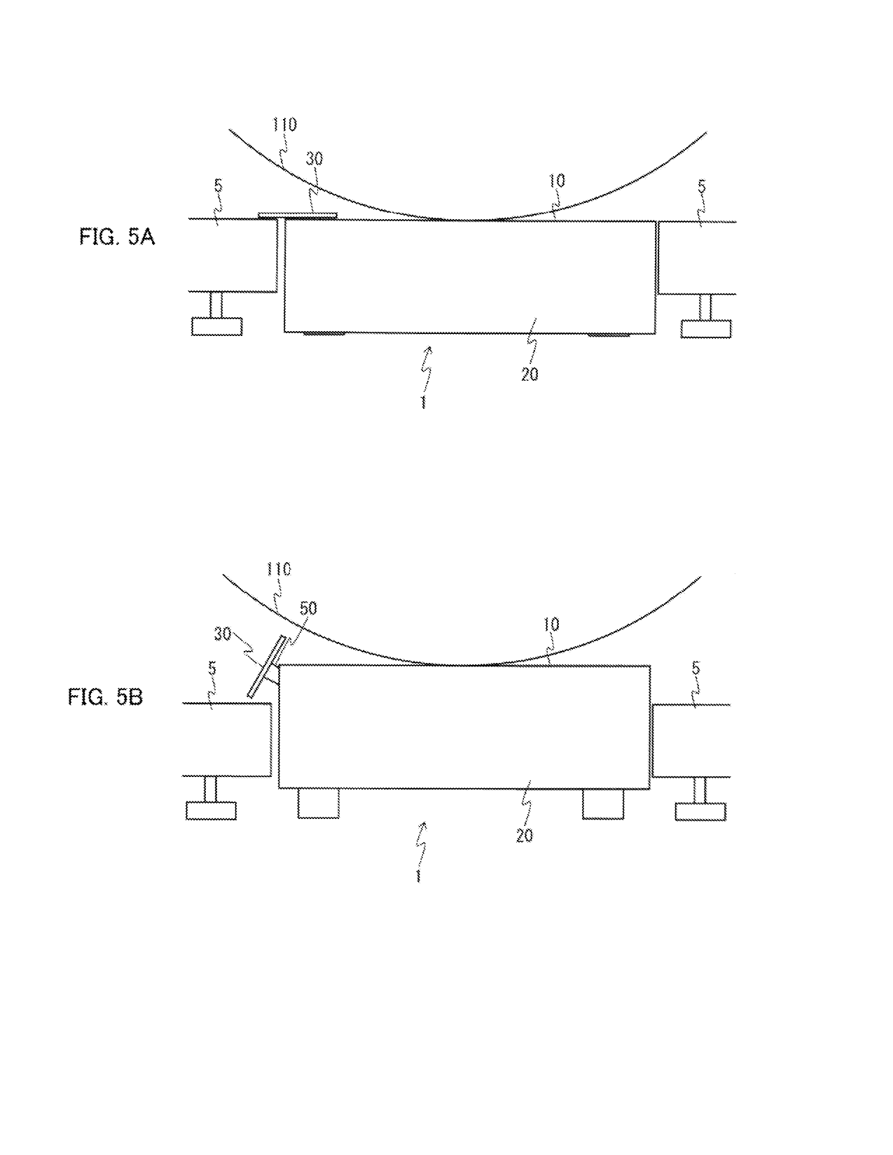

A detailed configuration of the orientation correction apparatus 1 will be described with reference to FIGS. 3 to 5. FIG. 3 is a perspective view showing the orientation correction apparatus 1 when the receiving platform 10 is positioned at a lowered position. FIG. 4 is a perspective view showing the orientation correction apparatus 1 when the receiving platform 10 is positioned at a raised position. FIGS. 5A and 5B are each a schematic view for explaining a standby position and the restricting position of the stopper 30. FIG. 5A shows the stopper 30 positioned at the standby position, and FIG. 5B shows the stopper 30 positioned at the restricting position. In FIG. 4, the stopper 30 is made transparent for convenience of explanation.

As described above, a plurality of orientation correction apparatuses 1 are provided at positions corresponding to respective wheels 110 of the vehicle 100, but the configuration of each orientation correction apparatus 1 is the same. Therefore, hereinafter, the configuration of the orientation correction apparatus 1 provided at the position corresponding to the wheel 110 (here, the right front wheel) on the front side of the vehicle 100 will be described.

It is assumed here that the vehicle 100 is a truck. When the vehicle 100 is a truck, the vehicle height of the vehicle 100’s front portion tends to be low, making it more common to raise the receiving platform 10 of the wheel 110 on the front side of the vehicle 100. As a result, the effect of providing the stopper 30 is more effectively achieved.

As illustrated in FIG. 3, the orientation correction apparatus 1 includes the receiving platform 10, a conveyor unit 15, a lifting mechanism 20, the stopper 30, a pusher 40, and a pivot support unit 50.

The receiving platform 10 supports one wheel 110 of the vehicle 100 positioned at the stopping position. Here, the receiving platform 10 supports the right front wheel 110 of the truck. The length of the receiving platform 10 in the front-rear direction is smaller than the diameter of the wheel 110. In this case, while the receiving platform 10 can be made more compact, the risk of the wheel 110 falling from the receiving platform 10 increases. However, by providing the stopper 30, the effect of preventing the wheel 110 from falling from the receiving platform 10 while the receiving platform 10 is rising is more effectively achieved. The receiving platform 10 moves up and down between the lowered position shown in FIG. 3 and the raised position shown in FIG. 4. When the wheel 110 of the vehicle 100 moves on the vehicle platform 5 (FIG. 1), the receiving platform 10 is positioned at the lowered position. When the orientation of the wheel 110 is corrected, the receiving platform 10 moves from the lowered position to the raised position.

The conveyor unit 15 is provided on the upper surface of the receiving platform 10, and has a function of moving the wheel 110 supported by the receiving platform 10 in the vehicle width direction. The conveyor unit 15 includes a plurality of rollers 17 provided at predetermined intervals in the vehicle width direction. The wheel 110 is in contact with some of the rollers 17 among the plurality of rollers 17. The wheel 110 can be moved in the vehicle width direction by the rotation of the rollers 17, which are in contact with the wheel 110. The receiving platform 10 moves up and down between the lowered position and the raised position in a state where the wheel 110 is in contact with the rollers 17.

The lifting mechanism 20 moves the receiving platform 10 up and down. The lifting mechanism 20 lifts and lowers the receiving platform 10 supporting the wheel 110 between the lowered position and the raised position. The lifting mechanism 20 has a motor as a power source, and moves the receiving platform 10 up and down using the motor’s power.

The lifting mechanism 20 includes a lifting unit 25 that lifts and lowers together with the receiving platform 10. The lifting unit 25 is formed in a plate shape here, and is positioned on a side surface of the receiving platform 10. The lifting unit 25 is provided with a plurality of pivot support units 50, as shown in FIG. 3.

The stopper 30 restricts movement of the wheel 110 from the receiving platform 10. The stopper 30 is a plate member. The stopper 30 is provided so that its longitudinal direction is parallel to the vehicle width direction. The stopper 30 restricts the wheel 110 from falling from the receiving platform 10 when the receiving platform 10 is positioned at the raised position. Here, the stopper 30 is positioned behind the wheel 110 in the front-rear direction of the vehicle 100, and restricts the wheel 110 from falling from the receiving platform 10 rearward.

The stopper 30 is provided such that its position can be changed. When the receiving platform 10 is in the raised position, as shown in FIG. 4, the stopper 30 is positioned at the restricting position for restricting the movement of the wheel 110 from the receiving platform 10. On the other hand, when the receiving platform 10 is in the lowered position, as shown in FIG. 3, the stopper 30 is positioned at the standby position. When the stopper 30 is positioned at the standby position, the stopper 30 does not restrict the movement of the wheel 110.

The stopper 30 moves between the standby position and the restricting position. Specifically, the stopper 30 moves between the standby position shown in FIG. 5A and the restricting position shown in FIG. 5B in conjunction with the movement of the receiving platform 10. For example, the stopper 30 positioned at the standby position moves toward the restricting position when the receiving platform 10 moves from the lowered position to the raised position. In this manner, the position of the stopper 30 changes in accordance with the movement of the receiving platform 10.

The stopper 30 is positioned so as to intersect with the lifting direction (vertical direction) when it is positioned at the restricting position. Specifically, the stopper 30 positioned at the restricting position is inclined with respect to the lifting direction. More specifically, as shown in FIG. 5B, the angle between the upper surface of the stopper 30, which is positioned at the restricting position, and the upper surface of the receiving platform 10 is smaller than 90 degrees. In this case, even if a force applied by the wheel 110 to the plate-shaped stopper 30 increases, the stopper 30 does not deform and can more effectively support the wheel 110.

As shown in FIG. 5A, the stopper 30 covers the gap between the receiving platform 10 and the vehicle platform 5 (FIG. 1) when the stopper 30 is positioned at the standby position. When the stopper 30 is positioned at the standby position, the upper surface of the stopper 30 may be flush with the upper surface of the receiving platform 10. For example, a recess is formed in the upper surface of the receiving platform 10, and by having the stopper 30 positioned in the recess, the upper surface of the stopper 30 is flush with the upper surface of the receiving platform 10. However, the configuration is not limited to this, and the upper surface of the stopper 30 may be positioned above the upper surface of the receiving platform 10 by an amount corresponding to the thickness of the stopper 30. In this case, the stopper 30 overlaps with part of the upper surface of the receiving platform 10. Therefore, the wheel 110 passes over the stopper 30 in the standby position and then is positioned on the receiving platform 10. In the absence of the stopper 30, there is a risk that an impact may act on the wheel 110 when the wheel 110 passes through the gap between the vehicle platform 5 and the receiving platform 10. However, by covering the gap, the stopper 30 enables the wheel 110 to move smoothly.

The pusher 40 functions to push up the stopper 30 when the receiving platform 10 moves from the lowered position to the raised position. Specifically, as the receiving platform 10 moves to the raised position, the pusher 40 pushes up the stopper 30 from the standby position to the restricting position.

The pusher 40 is provided below the stopper 30. Specifically, as shown in FIG. 3, two pushers 40 are provided below both ends of the stopper 30 in the longitudinal direction. The pusher 40 has an elongated plate-like shape. One end 42 of the pusher 40 in the longitudinal direction can contact the lower surface of the stopper 30. The stopper 30 is pushed up as each end 42 of the two pushers 40 pushes against the lower surface of the stopper 30.

The pusher 40 is connected to the lifting unit 25 below the stopper 30. The pusher 40 is supported by a support shaft 26 connected to the lifting unit 25. Specifically, the central portion of the pusher 40 in the longitudinal direction is supported by the support shaft 26. Therefore, the pusher 40 rotates about the support shaft 26 in conjunction with the lifting and lowering of the lifting unit 25. For example, the pusher 40 rotates in direction C1 (see FIG. 3) about the support shaft 26 in conjunction with the lifting of the lifting unit 25 and rotates in direction C2 (see FIG. 3) about the support shaft 26 in conjunction with the lowering of the lifting unit 25.

The other end 43 of the pusher 40 in the longitudinal direction is coupled to a wheel unit 62 that rolls on a guide unit 60. The guide unit 60 is provided in a rod shape, parallel to the vehicle width direction. The wheel unit 62 rolls on the guide unit 60 by receiving power from the motor that moves the receiving platform 10 up and down. A link member 64 coupled to the receiving platform 10 is coupled to the wheel unit 62. The link member 64 is pivotably supported by, for example, the lifting unit 25.

The other end 43 of the pusher 40 is coupled to a rotation axis of the wheel unit 62 to which the link member 64 is coupled. Therefore, when the wheel unit 62 rolls on the guide unit 60, the pusher 40 pivots together with the link member 64. Specifically, when the wheel unit 62 rolls on the guide unit 60 in the direction of arrow A1 (FIG. 4), the link member 64 and the pusher 40 rotate in the direction C1 (FIG. 3), the receiving platform 10 moves to the raised position, and the pusher 40 moves to the restricting position. On the other hand, when the wheel unit 62 rolls on the guide unit 60 in the direction opposite to the arrow A1, the link member 64 and the pusher 40 rotate in the direction C2 (FIG. 3), the receiving platform 10 moves to the lowered position, and the pusher 40 moves to the standby position.

The pivot support unit 50 pivotably supports the stopper 30. The pivot support unit 50 supports the lower surface of the stopper 30. A plurality of pivot support units 50 are provided at predetermined intervals in the longitudinal direction of the lifting unit 25. Therefore, the pivot support units 50 pivotably support the stopper 30 relative to the lifting unit 25.

The stopper 30 pivots about the pivot support unit 50 due to the pusher 40 pushing up the stopper 30. That is, the stopper 30 pivots about the rotation axis of the pivot support unit 50 and moves from the standby position to the restricting position as the pusher 40 pushes up the stopper 30.

The lifting mechanism 20 moves the receiving platform 10 and the stopper 30 using the motor’s power. For example, the lifting mechanism 20 moves the stopper 30 from the standby position to the restricting position in conjunction with the movement of the receiving platform 10 from the lowered position to the raised position. Specifically, the lifting mechanism 20 causes the stopper 30 to pivot and positions it at the restricting position in conjunction with the linear movement of the receiving platform 10 from the lowered position to the raised position.

Further, the lifting mechanism 20 moves the stopper 30 from the restricting position to the standby position in conjunction with the movement of the receiving platform 10 from the raised position to the lowered position. Specifically, the lifting mechanism 20 causes the stopper 30 to pivot and positions it to the standby position in conjunction with the movement of the receiving platform 10 from the raised position to the lowered position. By doing this, the lifting mechanism 20 can move not only the receiving platform 10 but also the stopper 30 using the motor’s power.

### Modification

In the embodiment described above, the stopper 30 restricts the rearward movement of the wheel 110 on the receiving platform 10. However, the present disclosure is not limited to this configuration.

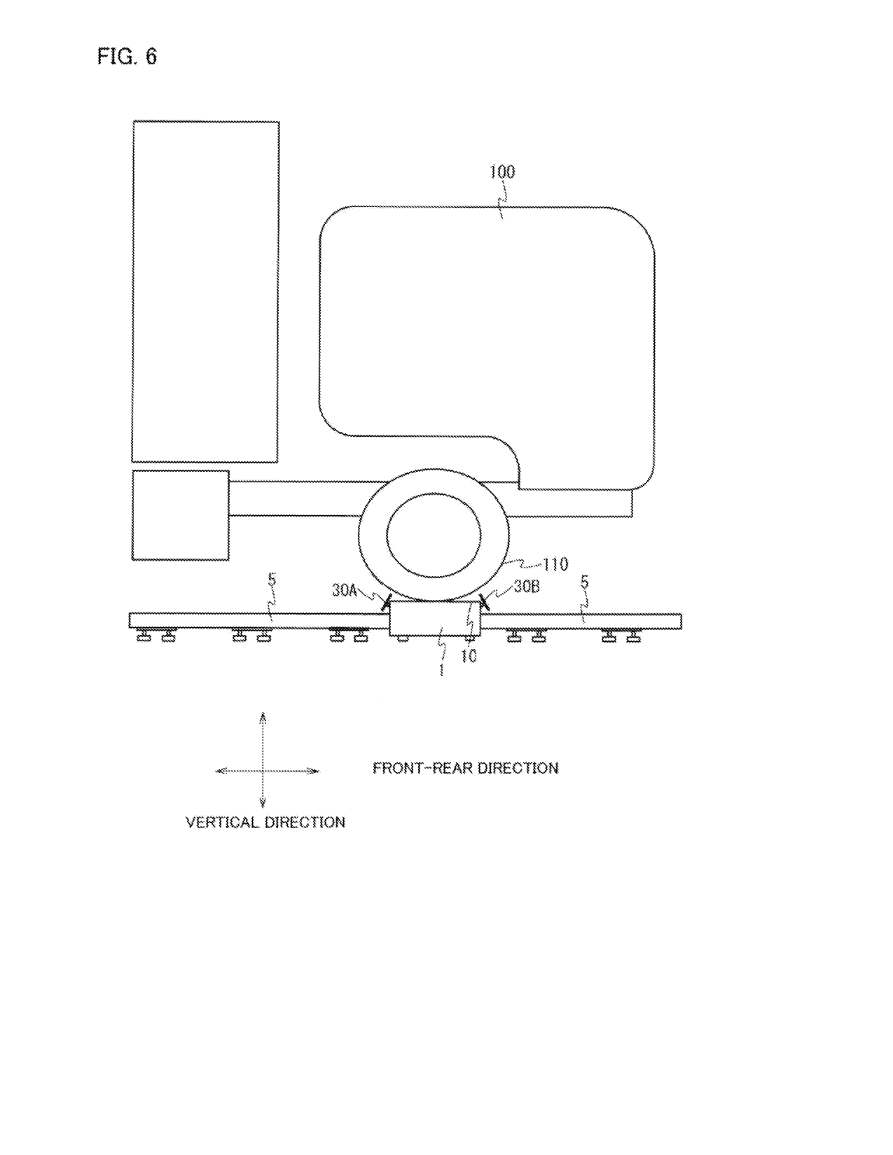

FIG. 6 is a schematic diagram illustrating a modification. In the modification, two stoppers 30A and 30B are provided. The stopper 30A is provided at a rear portion of the receiving platform 10 in the front-rear direction, and the stopper 30B is provided at a front portion of the receiving platform 10 in the front-rear direction. That is, the stopper 30A is positioned rearward of the center of the wheel 110 supported by the receiving platform 10, and the stopper 30B is positioned forward of the center of the wheel 110.

The stopper 30A is a first stopper that restricts rearward movement of the wheel 110 supported by the receiving platform 10. The stopper 30B is a second stopper that restricts forward movement of the wheel 110 supported by the receiving platform 10. By providing the two stoppers 30A and 30B in this manner, the wheel 110 can be prevented from falling from the receiving platform 10 due to an external force. Since the configurations of the stoppers 30A and 30B are the same as those of the stopper 30 described above, detailed description thereof will be omitted.

The lifting mechanism 20 moves the stoppers 30A and 30B from the standby position to the restricting position in conjunction with the movement of the receiving platform 10 from the lowered position to the raised position. For example, the lifting mechanism 20 simultaneously causes the stopper 30A and the stopper 30B to pivot about the rotation axis of the pivot support unit 50 from the standby position to the restricting position. Thus, the stoppers 30A and 30B can be operated without providing separate power sources for driving the stoppers 30A and 30B.

In the modification, the two stoppers 30A and 30B are provided, but only the stopper 30B that restricts the forward movement of the wheel 110 need be provided.

Further, in the above description, the stopper 30 pivots about the pivot support unit 50 between the standby position and the restricting position, but the present disclosure is not limited thereto. For example, the stopper 30 may move linearly along the vertical direction together with the receiving platform 10.

Further, in the above description, the orientation correction apparatus 1 provided at the position corresponding to a front wheel of the vehicle 100 includes the stopper 30, but is not limited thereto. For example, the orientation correction apparatus 1 provided at a position corresponding to a rear wheel of the vehicle 100 may include the stopper 30. Each of the orientation correction apparatuses 1 provided at positions corresponding to the wheels of the vehicle 100 may include the stopper 30.

### EFFECT OF EMBODIMENT

The orientation correction apparatus 1 of the above-described embodiment includes the lifting mechanism 20 that lifts and lowers the receiving platform 10 between the lowered position and the raised position, and the stopper 30 that (i) is positioned at the standby position when the receiving platform 10 is in the lowered position and (ii) is positioned at the restricting position to restrict the movement of the wheel 110 from the receiving platform 10 when the receiving platform 10 is at the raised position. The lifting mechanism 20 moves the stopper 30 from the standby position to the restricting position in conjunction with the movement of the receiving platform 10 from the lowered position to the raised position. Thus, when the receiving platform 10 supporting the wheel 110 moves to the raised position, the stopper 30 moves to the restricting position. Therefore, if the wheel 110 shifts upon receiving an external force while the receiving platform 10 rises, the wheel 110 comes into contact with the stopper 30, thereby preventing the wheel 110 from falling from the receiving platform 10.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

What is claimed is:

1. An orientation correction apparatus for correcting an orientation of a vehicle, the orientation correction apparatus comprising:
a receiving platform that supports one wheel of the vehicle;
a lifting mechanism that lifts and lowers the receiving platform, which supports the wheel, between a lowered position and a raised position; and
a stopper that is positioned at a standby position when the receiving platform is in the lowered position, and is positioned at a restricting position for restricting movement of the wheel from the receiving platform when the receiving platform is in the raised position, wherein the lifting mechanism moves the stopper from the standby position to the restricting position in conjunction with movement of the receiving platform from the lowered position to the raised position.

2. The orientation correction apparatus according to claim 1, wherein the lifting mechanism causes the stopper to pivot and positions the stopper at the restricting position in conjunction with linear movement of the receiving platform from the lowered position to the raised position.

3. The orientation correction apparatus according to claim 1, wherein the stopper is a plate member, and the stopper is positioned so as to intersect with a lifting direction when being positioned at the restricting position.

4. The orientation correction apparatus according to claim 3, wherein an angle between an upper surface of the stopper, which is positioned at the restricting position, and an upper surface of the receiving platform is smaller than 90 degrees.

5. The orientation correction apparatus according to claim 1, wherein the stopper is a plate member, and the stopper is positioned so that an upper surface of the stopper and an upper surface of the receiving platform are flush with each other in a state of being positioned at the standby position, and overlaps with part of the upper surface of the receiving platform.

6. The orientation correction apparatus according to claim 1, wherein the lifting mechanism includes a lifting unit that lifts and lowers together with the receiving platform, and
the orientation correction apparatus further comprises a pusher that is connected to the lifting unit below the stopper and pushes up the stopper in conjunction with the lifting of the lifting unit.

7. The orientation correction apparatus according to claim 6, wherein the pusher is supported by a support shaft connected to the lifting unit, and rotates about the support shaft in accordance with the lifting and lowering of the lifting unit.

8. The orientation correction apparatus according to claim 6, further comprising:
a pivot support unit that pivotably supports the stopper relative to the lifting unit, wherein the stopper pivots about the pivot support unit due to the pusher pushing up the stopper.

9. The orientation correction apparatus according to claim 1, wherein the stopper includes:
a first stopper that restricts rearward movement of the wheel supported by the receiving platform; and
a second stopper that restricts forward movement of the wheel, and
the lifting mechanism moves the first stopper and the second stopper from the standby position to the restricting position in conjunction with movement of the receiving platform from the lowered position to the raised position.

10. The orientation correction apparatus according to claim 1, wherein the vehicle is a truck, and the receiving platform supports a front wheel of the truck.
